(19) United States
(12) Patent Application Publication
(10) Pub. No.: US 2008/0287632 A1
(43) Pub. Date: Nov. 20, 2008

(54) Stabilization of Monomer Emulsions Against Premature Polymerization

(75) Inventors: Thorsten Goldacker, Rossdorf (DE); Reiner Mueller, Biebesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Roehm GmbH, Darmstadt (DE)

(21) Appl. No.: 12/091,317

(22) PCT Filed: Oct. 2, 2006
(86) PCT No.: PCT/EP2006/066944

§ 371 Date: Apr. 24, 2008

(30) Foreign Application Priority Data
Dec. 6, 2005 (DE) 10 2005 058 608.2

(51) Int. Cl. B01F 3/08; C08F 118/02

(52) U.S. Cl. 526/319; 516/9

(57) ABSTRACT

The invention relates to a stable formulation of a monomer emulsion, to a process for its preparation and to its uses.

The invention relates to a stable formulation of a monomer emulsion, to a process for its preparation and to its uses.

In the course of storage of monomers, the problem of undesired polymerization occurs in most instances. Stabilization by free radical-scavenging organic or inorganic substances is known. For instance, Tüdos et al. [Tüdos, E., Földes-Berezsnich, T., Prog. Polym. Sci., Vol. 14, 1989, 717] describe a multitude of inhibitors which are capable of reacting with free radicals to give stable compounds and thus effectively suppress the undesired polymerization. Examples include quinones, aromatic nitro compounds, nitroso compounds, phenols and aromatic amines.

The U.S. Pat. No. 3,082,262 describes NaNO₂ as a stabilizer in the emulsion polymerization of 3-chloro-1,3-butadiene. Reference is also made here to the advantageous effect of a pH of 6 to 13.5, but always in conjunction with the stabilizer mentioned. Emulsion level experiments are not performed; the stabilizing action is merely observed with regard to the course of polymerization.

All free radical stabilizers described have the disadvantage that they, when they are used in a thermoplastic moulding composition, discolour it by decomposition under the processing conditions, which generally leads to an undesired rise in the yellowness.

Likewise disadvantageous is the inhibition of the desired polymerization in the course of and after the emulsion has been fed into the polymerization vessel. It is correspondingly necessary to use more initiator here in order to “overrun” the stabilizer. The additional amount of initiator required leads to more decomposition products, some or all of which remain in the product and, like the inhibitors, adversely affect properties including the appearance.

It is an object of the invention to stabilize a monomer emulsion effectively against premature, uncontrolled polymerization. Since the moulding composition obtained as a conversion product from the dispersion should be highly colourless and transparent, less free radical stabilizer should be used, since this leads to yellowing of the product in the course of processing.

The object is achieved by a stabilized monomer emulsion whose pH is adjusted to 9-14.

Small amounts of a base adjust the monomer emulsion to a pH of 9-14.

It has been found that, surprisingly, this suppresses the polymerization and allows reliable working with the concentrated emulsion to be ensured.

It has been found that the effectiveness of the pH adjustment even exceeds that of the phenolic stabilizer Irganox 1076 (Ciba) used for comparative purposes.

Also provided is a process for preparing stabilized monomer emulsions.

The impact modifier dispersion is prepared by emulsion polymerization with two emulsion feeds. In a subsequent step, the solid is isolated and processed as a moulding composition. In order to increase the yield of the solid, the solids content of the dispersion should be increased. To this end, an increase in the monomer content in the feed emulsions is required. In addition to the monomers and the emulsifier, both feeds comprise an organic peroxide as an initiator, which reacts in a redox reaction with the reducing agent which is already present in the polymerization vessel to generate free radicals. This decomposition reaction is catalysed, for example, with by iron(II) ions, which are likewise present in small amounts in the initial charge. Since the molecular weight is to be regulated in the second polymerization phase, a mercaptan is also present as a regulator in the feed emulsion. Like all mercaptans, the regulator can act as a reducing agent and lead to undesired initiator decomposition as early as in the course of provision of the feed emulsion and thus trigger premature polymerization. In order to obtain a product having the desired properties, it is absolutely necessary that both the regulator and the initiator are present in the feed emulsion; a second, parallel feed is not an alternative.

In order to ensure reliable working with the 2nd feed emulsion, an emulsion level experiment was established, in which a critical operational fault during production is simulated. A failure of the delivery pumps and of the stirring in the emulsion tank is simulated. Even under these conditions, there must not be any uncontrolled polymerization of the monomer emulsion. In the laboratory test, the emulsion is heated to 45° C. with stirring in the presence of 10 ppm of Fe(II) ions and then kept at 45° C. for 8 h without stirring. It is also possible to use Cr, Mn and similar materials, which are common impurities. The iron ions are intended to simulate the leaching of iron out of the tank and pipeline walls, and make the test more severe by virtue of their catalytic action. The evolution of heat (measured as the temperature difference ΔT between the internal and external temperature) and the polymer content after expiry of the 8 h are measured. The less heat is formed and the lower the polymer content detected, the more stable the emulsion.

The pH is adjusted to 9-14, preferably to 9-11, most preferably to 10.

To adjust the pH, any bases may be used. Preference is given to using ammonia, water-soluble amines, alkali metal carbonates and hydrogencarbonates, and also alkali metal hydroxides, more preferably sodium hydroxide.

To adjust the pH, depending on the base used, 0.0001-10% by weight are. For NaOH, preference is given to adding 0.001-5% by weight, particular preference to adding 0.005% by weight of base.

The mixture is stabilized by means of emulsifiers and/or protective colloids. Preference is given to stabilization by emulsifiers in order to obtain a low dispersion viscosity. The total amount of emulsifier is preferably 0.1 to 5% by weight, in particular 0.5 to 3% by weight, based on the total weight of the monomers. Particularly suitable emulsifiers are anionic or nonionic emulsifiers or mixtures thereof, in particular:
alkyl sulphates, preferably those having 8 to 18 carbon atoms in the alkyl radical, alkyl ether sulphates and alkylaryl ether sulphates having 8 to 18 carbon atoms in the alkyl radical and 1 to 50 ethylene oxide units;
sulphonates, preferably alkyl sulphonates having 8 to 18 carbon atoms in the alkyl radical, alkylaryl sulphonates having 8 to 18 carbon atoms in the alkyl radical, esters and monoesters of sulphosuccinic acid with monohydric alcohols or alkylphenols having 4 to 15 carbon atoms in the alkyl radical; optionally, these alcohols or alkylphenols may also be ethoxylated with 1 to 40 ethylene oxide units;
phosphoric part-esters and their alkali metal and ammonium salts, preferably alkyl phosphates and alkylaryl phosphates having 8 to 20 carbon atoms in the alkyl or alkylaryl radical and 1 to 5 ethylene oxide units;
alkyl polyglycol ethers, preferably having 8 to 20 carbon atoms in the alkyl radical and 8 to 40 ethylene oxide units;
alkylaryl polyglycol ethers, preferably having 8 to 20 carbon atoms in the alkyl or alkylaryl radical and 8 to 40 ethylene oxide units;
ethylene oxide/propylene oxide copolymers, preferably block copolymers, favourably having 8 to 40 ethylene oxide or propylene oxide units.

Optionally, the emulsifiers may also be used in a mixture with protective colloids. Suitable protective colloids include part-hydrolysed polyvinyl acetates, polyvinylpyrrolidones, carboxymethyl-, methyl-, hydroxyethyl-, hydroxypropylcellulose, starches, proteins, poly(meth)acrylic acid, poly(meth)acrylamide, polyvinylsulphonic acids, melamine-formaldehyde sulphonates, naphthalene-formaldehyde sulphonates, styrene-maleic acid and vinyl ether-maleic acid copolymers. If protective colloids are used, this is preferably done in an amount of 0.01 to 1.0% by weight based on the total amount of the monomers. The protective colloids can be initially charged before the start of the polymerization or metered in.

The chain lengths can be controlled by polymerizing the monomer or the monomer mixture in the presence of molecular weight regulators, especially the mercaptans known for this purpose, for example n-butyl mercaptan, n-dodecyl mercaptan, 2-mercaptoethanol or 2-ethylhexyl thioglycolate, pentaerythrityl tetrathioglycolate; the molecular weight regulators being used generally in amounts of 0.05 to 5% by weight, based on the monomer mixture, preferably in amounts of 0.1 to 2% by weight and more preferably in amounts of 0.2 to 1% by weight to the monomer mixture (cf., for example, H. Rauch-Puntigam, Th. Völker, “Acryl- und Methacrylverbindungen”, Springer, Heidelberg, 1967; Houben-Weyl, Methoden der organischen Chemie, Vol. XIV/1, page 66, Georg Thieme, Heidelberg, 1961 or Kirk-Othmer, Encyclopedia of Chemical Technology, Vol. 1, pages 296 et seq., J. Wiley, New York, 1978). The molecular weight regulator used is preferably n-dodecyl mercaptan.

The initiation is effected with the initiators commonly used for emulsion polymerization. Suitable organic initiators are, for example, azo compounds or hydroperoxides such as tert-butyl hydroperoxide or cumene hydroperoxide. Suitable inorganic initiators are hydrogen peroxide, and also the alkali metal salts and the ammonium salts of peroxodisulphuric acid, especially sodium peroxodisulphate and potassium peroxodisulphate. The initiators mentioned may be used either individually or in a mixture. They are preferably used in an amount of 0.05 to 3.0% by weight, based on the total weight of the monomers of the particular stage.

The notation (meth)acrylate represents the esters of (meth)acrylic acid and here means both methacrylate, for example methyl methacrylate, ethyl methacrylate, etc., and acrylate, for example methyl acrylate, ethyl acrylate, etc., and also mixtures of the two.

The monomers used may be, for example: alkyl (meth)-acrylates of straight-chain, branched or cycloaliphatic alcohols having 1 to 40 carbon atoms, for example methyl (meth)acrylate, ethyl (meth)acrylate, n-butyl (meth)acrylate, i-butyl (meth)acrylate, t-butyl (meth)acrylate, pentyl (meth)acrylate, 2-ethylhexyl (meth)acrylate, stearyl (meth)acrylate, lauryl (meth)acrylate, cyclohexyl (meth)acrylate, isobornyl (meth)acrylate; aryl (meth)acrylates, for example benzyl (meth)acrylate or phenyl (meth)acrylate, each of which may have unsubstituted or mono- to tetrasubstituted aryl radicals; other aromatically substituted (meth)acrylates, for example naphthyl (meth)acrylate; mono(meth)acrylates of ethers, polyethylene glycols, polypropylene glycols or mixtures thereof having 5-80 carbon atoms, for example tetrahydrofurfuryl methacrylate, methoxy(m)ethoxyethyl methacrylate, 1-butoxypropyl methacrylate, cyclohexyloxy-methyl methacrylate, benzyloxymethyl methacrylate, furfuryl methacrylate, 2-butoxyethyl methacrylate, 2-ethoxyethyl methacrylate, allyloxymethyl meth-acrylate, 1-ethoxybutyl methacrylate, 1-ethoxyethyl methacrylate, ethoxymethyl methacrylate, poly(ethylene glycol) methyl ether (meth)acrylate, and poly(propylene glycol) methyl ether (meth)acrylate.

The stabilized monomer emulsions feature good storage stability. These emulsions are preferably polymerized to polymer dispersions. These polymer dispersions are preferably used in moulding compositions, especially in impact-resistant moulding compositions.

The examples given below are given for better illustration of the present invention, but are not capable of restricting the invention to the features disclosed herein.

### EXAMPLES

| Emulsion | | | | | |
|---|---|---|---|---|---|
| No. | 1 | 2 | 3 | 4 | 5 |
| De- | 196.53 | 196.53 | 185.00 | 185.00 | 185.00 |
| mineralized | | | | | |
| water [g] | | | | | |
| Marlon PS | 0.33 | 0.33 | 0.33 | 0.33 | 0.33 |
| 60⁽¹⁾ [g] | | | | | |
| Trigonox | 0.31 | 0.31 | 0.31 | 0.31 | 0.31 |
| AW 70⁽²⁾ [g] | | | | | |
| MMA⁽³⁾ [g] | 275.79 | 275.79 | 289.77 | 289.77 | 289.77 |
| n-BA⁽⁴⁾ [g] | 24.01 | 24.01 | 25.23 | 25.23 | 25.23 |
| Dodecyl | 2.40 | 2.40 | 2.40 | 2.40 | 2.40 |
| mercaptan | | | | | |
| [g] | | | | | |
| FeSO₄• | 0.0005 | 0.0005 | 0.0005 | 0.0005 | 0.0005 |
| 7H₂O [g] | | | | | |
| Stabi1izer⁽⁵⁾ | — | 0.30 | — | 0.315 | — |
| [g] | | | | | |
| 5% NaOH | — | — | — | — | 0.5 |
| solution [g] | | | | | |

⁽¹⁾C15 sodium paraffinsulphonate, from Condea
⁽²⁾70% alcoholic aqueous solution of tert-butyl hydroperoxide, from Akzo Nobel
⁽³⁾methyl methacrylate
⁽⁴⁾n-butyl acrylate
⁽⁵⁾Irganox 1076 (octadecyl 3-(3,5-di-tert-butyl-4-hydroxy-phenyl)propionate, from Ciba)

At room temperature, the reactants specified are mixed and emulsified with high shear (Ultraturrax, IKA T25 rotor-stator shear tool, 5 min, 9000 rpm):

The stabilizer used is Irganox 1076 (octadecyl 3-(3,5-di-tert-butyl-4-hydroxyphenyl)propionate, from Ciba), a common phenolic free radical scavenger.

All monomers were stabilized in the same way with small amounts of hydroquinone monomethyl ether.

The emulsions are introduced into a round-bottomed flat-flanged vessel made of glass with internal temperature sensor, stirrer and reflux condenser, which is in a water bath heated to 45° C. Once the internal temperature has balanced out, the stirrer is switched off and the vessel is kept at external temperature 45° C. for 8 h. Subsequently, the emulsion is homogenized by stirring it up again and stabilized with 0.05 g of hydroquinone monomethyl ether, and the polymer content is determined as a nonvolatile solid with a dry balance.

| Emulsion | Monomer | pH of the | Polymer | |
|---|---|---|---|---|
| No. | conc. in % | emulsion | content in % | ΔT in ° C. |
| 1 | 60 | 6 | 18.11 | n.d.⁽¹⁾ |
| 2 | 60 | 6 | 6.91 | n.d. |
| 3 | 63 | 6 | thickened⁽²⁾ | n.d. |
| 4 | 63 | 6 | 7.50 | n.d. |
| 5 | 63 | 10 | 4.70 | n.d. |

⁽¹⁾n.d. = not determinable; within the range of measurement accuracy, no temperature change was detected.
⁽²⁾when the emulsion thickens, the test is not passed and the polymer content is not measured.

The polymer content of the concentrated 63% emulsions is the lowest after storage with the variant of pH adjustment, i.e. the stabilization against undesired polymerization is the most effective.

1. Stabilized monomer emulsion, characterized in that the monomer emulsion is adjusted to a pH of 9-14.

2. Stabilized monomer emulsion according to claim 1, characterized in that the monomer emulsion comprises a base.

3. Stabilized monomer emulsion according to claim 2, characterized in that the monomer emulsion comprises NaOH, KOH, Na₂CO₃ or K₂CO₃.

4. Stabilized monomer emulsion according to claim 1, characterized in that the monomer emulsion contains 0.0001-10% by weight of base.

5. Process for preparing a stabilized monomer emulsion, characterized in that (meth)acrylate monomers are emulsified with emulsifier, a base and further assistants and additives.

6. Process for preparing a stabilized monomer emulsion according to claim 5, characterized in that initiators are added.

7. Use of stabilized monomer emulsions according to claim 1 for polymerization to polymer dispersions.

8. Use of polymer dispersions according to claim 7 for processing to moulding compositions.
